(19) United States
(12) Patent Application Publication
(10) Pub. No.: US 2007/0118897 A1
(43) Pub. Date: May 24, 2007

(54) System and method for inhibiting access to a computer

(76) Inventors: Paul J. Munyon, Tallahassee, FL (US); Gay L. Munyon, Tallahassee, FL (US)

Correspondence Address: J. WHILEY HORTON, ESQUIRE;Pennington, Moore, Wilkinson, Bell & Dunbar, P.A., Post Office Box 10095, Tallahassee, FL, 32302-2095, US

(21) Appl. No.: 11/269,996

(22) Filed: Nov. 9, 2005

(51) Int. Cl. G06F 12/14

(52) U.S. Cl. 726/22

(57) ABSTRACT

A computer security system which prevents an unauthorized user from accessing the computer system when an authorized user has already logged onto the computer system and has temporarily left the workstation. The computer security system generally includes a sensor which is configured to detect the presence of a person in the region around a workstation and a processing unit which logs out of the computer when a person is no longer present in the region. An optional calibration tool may be provided to set the sensitivity of the sensor and prevent accidental logging out when the authorized user is still present in the region around the workstation.

### BACKGROUND OF THE INVENTION

1. Field of the Invention

This invention relates to the field of computer security. More specifically, the present invention comprises a method and system for logging a user off or locking a user account on a computer when a user leaves a work station.

2. Description of the Related Art

Various devices exist for preventing the unauthorized access of computers. Most of these devices are directed to lockout mechanisms which prevent an unauthorized user from logging onto a computer.

For example, U.S. Pat. No. 5,960,084 to Angelo describes a method of enabling power to a computer system based upon the results of a two-piece user verification procedure. If the user does not provide the required “smart card” and password, power to the computer system is disabled.

Another example is U.S. Pat. No. 6,338,142 to Alsaadi. Alsaadi's patent discloses a lockout circuit which generates an interfering signal that disrupts the “power on” signal generated by the computer's power controller. The lockout circuit generates this interfering signal when triggered by a triggering device such as an Ethernet chip or a switch.

Yet another example is provided in U.S. Pat. No. 5,712,973 to Dayan et al. Dayan et al.'s patent discloses a security feature which renders a computer system inoperable when an unauthorized user moves the system out of a containment region. To accomplish this, Dayan et al. uses a radiation source, such as a radio frequency transmitter, to transmit radiation with particular characteristics throughout the containment zone. Logic circuitry is provided as part of the system to disable access when the radiation is no longer detected.

Many other devices are also known in the art. Like the aforementioned security systems, however, these devices are directed at preventing an unauthorized user from logging onto the system. None of the prior art devices prevent an unauthorized user from accessing the computer system if an authorized user has already logged onto the computer system and temporarily left the workstation.

### BRIEF SUMMARY OF THE INVENTION

The present invention comprises a computer security system which prevents an unauthorized user from accessing the computer system when an authorized user has already logged onto the computer system and has temporarily left the workstation. The computer security system generally includes a sensor which is configured to detect the presence of a person in the region around a workstation and a processing unit which logs out of the computer when a person is no longer present in the region. A time delay setting may be employed to restrict the log out process to instances where the user is away from the workstation for a specified period of time. An optional calibration tool may be provided to set the sensitivity of the sensor and prevent accidental logging out when the authorized user is still present in the region and the workstation.

### BRIEF DESCRIPTION OF THE SEVERAL VIEWS OF THE DRAWINGS

FIG. 1 is a perspective view, showing the present invention.

FIG. 2 is a schematic, showing the present invention.

FIG. 3 is a diagram, showing the present invention.

### REFERENCE NUMERALS IN THE DRAWINGS

10 computer security system

14 monitor

18 cord

22 A/D converter

26 central processing unit

12 computer

16 sensor

20 sensor signal transmitter

24 sensor/CPU interface

28 memory

30 program

34 sensor input

38 comparator

42 calibration tool

46 logoff module

32 calibration tool

36 signal sampler

40 signal criteria

44 command

### DETAILED DESCRIPTION OF THE INVENTION

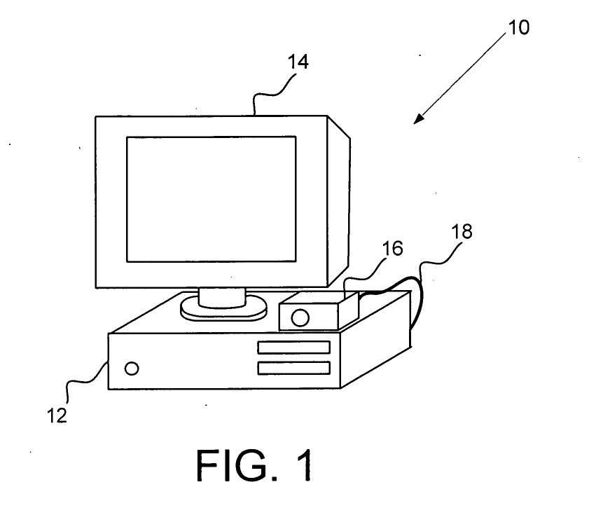

The present invention, computer security system 10, is illustrated in FIG. 1. Computer security system 10 is employed to prevent an unauthorized user from accessing the computer system if an authorized user has already logged onto the computer system and temporarily left the workstation. Computer security system 10 may be employed in any setting where one wishes to limit access.

As shown in FIG. 1, computer security system 10 includes sensor 16 which is plugged into computer 12 with cord 18. Cord 18 serves as a conduit for power and data transfer. Cord 18 may be a universal Serial Bus (“USB”) adapted cord or any other cord which will support data transfer between sensor 16 and computer 12. In addition, a separate power cord may also be provided to sensor 16 with its own transformer and wall plug. Computer 12 is also provided with monitor 14. Although a desktop-type computer is shown in FIG. 1, the invention may also be employed on a laptop computer. If a laptop is used, sensor 16 may either be external to the laptop or internally integrated.

Sensor 16 may be any type of sensing means that is configured to detect whether a person is present in the region around the user's workstation. As an example, sensor 16 may be a motion detector type sensor. Common motion detectors utilize microwave or infrared transmitter/receiver circuits. These sensors may be used to detect the movement of objects around the workstation. Sensor 16 may also be a thermal sensor which detects relative temperature of objects around the workstation. For example, sensor 16 may utilize “forward looking infrared” technology. In addition, sensor 16 may also be a camera or electro-optical sensor which captures a pictorial layout of the workstation and transmits the pictorial layout as sensory data (such as in an array of pixels). Pictorial type motion detectors compare frames of pixels with a reference frame. A processor then computes the degree of divergence between the reference frame and the “live action” frames. A greater description of these sensors is omitted here since these types of sensors are well known.

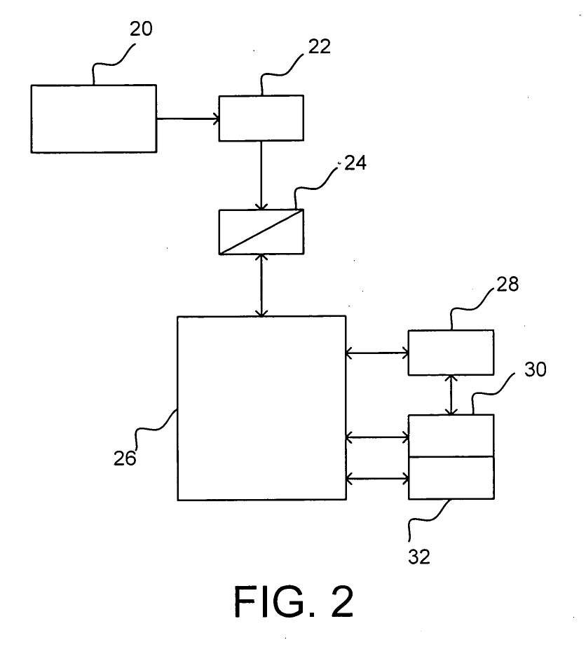

A schematic of an electronic circuit incorporating the present invention is provided in FIG. 2. Sensor signal transmitter 20 transmits sensory data from sensor 16 to the electronic circuit. The type of sensory data transmitted by sensor signal transmitter 20 depends on the type of sensor that is used. If a motion detector type sensor is used, sensor signal transmitter may send a simple signal indicating that movement has been detected in the region around the workstation. If a thermal sensor is utilized, thermal imagery data may be transmitted by sensor signal transmitter 20 or a simple “trigger level exceeded” signal.

Sensor signal transmitter 20 may transmit the sensory data to A/D converter 22 to convert the signal representing the sensory data from analog to digital format. Obviously, A/D converter 22 is not necessary if the sensor normally transmits in digital format. A/D converter 22 may be integrated with sensor 16 so that they are packaged together in one unit.

A/D converter 22 transmits the sensory data to sensor CPU interface 24. The sensory data may be any type of data that may be used to confirm the presence or absence of the user. For example, the sensory data may be a continuous stream of data from the sensor or a “trigger level exceeded” signal. In the preferred embodiment sensor/CPU interface 24 is a USB port, but other computer ports may similarly be used. Central processing unit 26 interfaces with sensor 16 through sensor/CPU interface 24. Central processing unit 26 is a processing means which is configured to process the sensory data and determine whether a person is present in the region around the workstation. Central processing unit 26 may be the central processing unit associated with the computer or it may be a standalone or computer-implanted processing device.

Central processing unit 26 is associated with memory 28. Memory 28 may be any type of memory unit that may be read by central processing unit 26 including RAM, ROM, computer readable disk, and other external storage devices. Memory 28 stores program 30 and calibration tool 32. Memory 28 may also service central processing unit 26's short-term memory needs. Program 30 is a computer program which includes a program module for directing central processing unit 26 in making a determination of whether a person is present in the region around the workstation. Calibration tool 32 includes a calibration module for calibrating program 30 with sensor 16 and the default state of the region around the workstation as will be described subsequently. It also may include a module for setting a sensitivity threshold for the sensor.

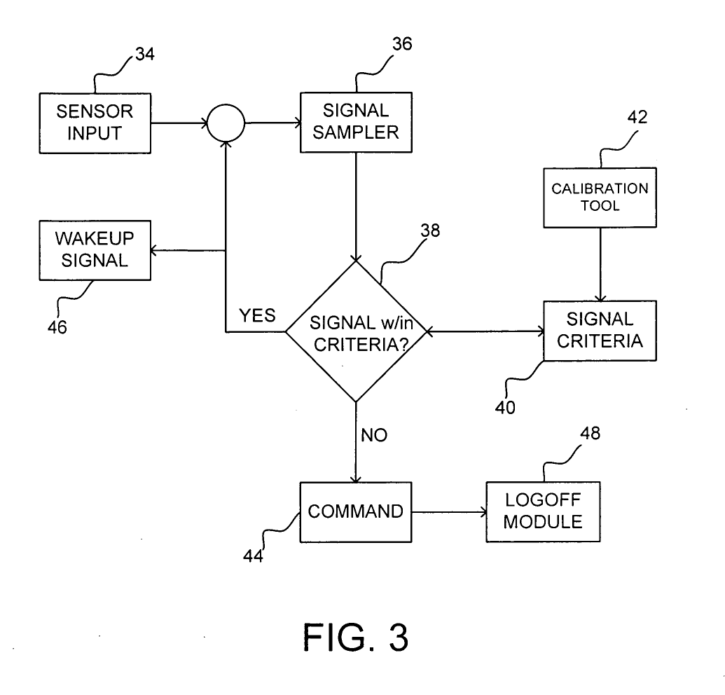

An information flow diagram illustrating the relationship between the various components of the present invention is provided in FIG. 3. Sensor input 34 represents the flow of sensory data to central processing unit 26. Sensory data is transmitted from sensor input 34 to signal sampler 36. Signal sampler 36 is a section of the program module which samples the sensory data for specific characteristics. Comparator 38 compares the sampled sensory data signal with stored sensory data describing a default state of the region around the workstation.

Calibration tool 42 represents the calibration module that may be used to calibrate the sensor and program module with a “default state” of the region around the workstation. “Default state” may describe the workstation when the authorized user of the computer is present or absent. If a motion detector type sensor is used, the default state is preferably the state of the region around the workstation when the authorized user is absent. Accordingly, a motion detector type sensor should be calibrated to a state where objects are not moving in the region around the workstation. Calibration tool 42 may be unnecessary for security systems with motion detector type sensors if the sensor sends a defined signal only when motion is detected in the area. Calibration tool 42 may still be useful in this situation, however, because the sensor/program module may be set to various “sensitivities.” For example, calibration tool 42 may be used to associate repetitive motion with the presence of a person in the workstation. On the other side, one movement that is detected in the span of 30 seconds may not be associated with the presence of a person.

For thermal sensors, the “default state” may be defined as either the presence or lack of a human heat signature. If the default state is defined by the absence of a person in the region around the workstation, calibration tool 42 may be used to take a thermal “snapshot” of the region around the workstation when a person is not present. If the default state is defined by the presence of a person in the region around the workstation, calibration tool 42 may be used to take a thermal snapshot when a person is present. As with motion detector type sensors, calibration tool 42 may also be used to set a sensitivity threshold for divergence from the “default state.” This feature is especially useful for thermal sensors as the workstation may see different temperature conditions throughout the year.

“Sensitivity threshold” corresponds to a measurable value for which divergence must equate or exceed before a sampled signal “meets the criteria” required by comparator 42. This divergence value may be set by the user when the user installs the security system at the workstation. It may need to be recalibrated over time—particularly if the environment around the workstation changes.

The value of divergence assigned by the user and required by comparator 42 will vary. It is dependant on the type of sensor that is used as well as the habits of the user and the characteristics of the region around the user's workstation. As mentioned with respect to motion detector type sensors, sensitivity threshold may define how many “motion” signals must be registered in a defined period of time. For thermal sensors, sensitivity threshold may define a required thermal contrast which must be observed or temperature range or “heat signature” that must be present.

As mentioned previously, camera type sensors may also be used to determine whether a person is in the region around a workstation. For example, a camera may collect digital imagery continuously or periodically of the area. Calibration tool 42 may be used to define the default state for either the case where the authorized user is present or absent. Using calibration tool 42, a pictorial snapshot may be taken of the area in the default state and stored for comparison purposes. Similar to thermal sensors, the camera type sensor may also be calibrated for the appropriate sensitivity threshold. Sensitivity threshold in the camera type sensor context may describe specific contrasts which must be achieved in terms of pixel array to meet the signal criteria required by comparator 38. Alternatively, sensitivity threshold may define how many pixels must be different in a live action frame from a reference frame.

Calibration and sensitivity threshold information is stored as signal criteria 40. Signal criteria 40 includes both sensory data regarding the default state and the sensitivity threshold parameters described previously. Comparator 38 compares sensory data signals received from signal sampler 36 with signal criteria 40 to determine whether the sensory data signal(s) meet signal criteria 40.

Although it has been mentioned that the default state may include both the cases where the authorized user is present and the case where the authorized user is absent, for purposes of illustration it will be assumed that the default state is that the user is absent. Accordingly, if a sensory data signal indicating that a person is present is sent to comparator 38, comparator 38 compares the signal with signal criteria 40 and will determine that signal criteria 40 is met. In the motion detector context, comparator 38 may receive sensory data signals indicating 5 registered movements over the past 30 seconds. In this case, comparator 38 may determine that the signals meet signal criteria 40, and signal comparator 38 continues to receive sensory data from signal sampler 30. In the thermal sensor context, comparator 38 may receive sensory data signals indicating that a certain thermal contrast was observed, comparator 38 may determine that the thermal contrast meets signal criteria 40 (if the thermal contrast corresponds to the thermal context expected with the presence of a human heat signature), and comparator 38 continues to receive sensory data from signal sampler 30.

Optionally, if a “YES” determination is made (if the signal meets the criteria), central processing unit 26 may also send wakeup signal 46. Wakeup signal 46 corresponds to a command signal which prevents a program from going into a rest state. For example, wakeup signal 46 may be a command signal that prevents the computers operating system from launching a “screen saver.” Wakeup signal 46 may similarly be used in other situations where the user does not want the computer to register an “idle” state. Many programs and Internet resources utilize these shut-down-at-idle mechanisms to conserve bandwidth and computer resources when they are “apparently” not being utilized. The user may in fact be using the program but may not have “shown” the program that it was still in use.

If a “NO” determination is made (signal does not meet criteria), central processing unit 26 sends command 44. Command 44 may be many different types of command signals. The exact command signal that is sent will depend on the type of operating system used by the authorized user and whether special authentication programs are used on the program. The command signal is generally configured, however, to block access to the computer until the authorized user completes an authentication process with respect to the computer. For MICROSOFT WINDOWS type operating system on a MICROSOFT type server, the command signal may be the object code equivalent of pressing the “Ctrl”, “Alt” and “Delete” keys simultaneously.

Command 44 generally triggers logoff module 48. Logoff module 48 may be any mechanism configured to block access until the user completes an authentication process. An actual “logging out” of the user's account may not be required in all cases. A specific module may be provided to prevent access and require authentication. This module may be provided in combination with program 30. Program 30 may be configured to operate in connection with various operating systems, servers, and authentication programs used by the user.

The invention may be better understood by the following example. In this example, the user has installed a microwave transmitter/receiver type motion detector sensor to the user's workstation computer. The motion detector sensor exchanges sensory data with the computer through a USB cord attached to one of the computer's USB ports. The user has installed program 30 with calibration tool 32 on the computers hard drive.

The computer's central processing unit 26 searches the computer's communication ports and recognizes that a microwave transmitter/receiver type motion detector sensor is plugged into the computer's USB port as part of the logging in protocols of program 30. The user may then open calibration tool 32 and run the calibration module. Calibration tool 32 translates the sensory data received from sensor 16 into descriptive “motion information” such as the number of movements detected by the sensor over time. The user may run the calibration module in background mode while working on other matters to gather information regarding the level of “motion activity” which is normally present in region around the workstation. If the user runs the module for an hour, calibration tool 32 may provide the following descriptive motion information to the user:
Run time: 60 minutes, 0 seconds
Total movements detected: 523
Longest idle: 36 seconds
Sensitivity setting: 5

This information means that over the course of the hour long calibration run, 523 total movements were detected by the sensor with a longest period of time between detected movements of 36 seconds. The sensitivity setting of the sensor was set to 5 (a medium sensitivity setting in a sensitivity range of 1 to 10). For microwave transmitter/receiver type motion detectors, the sensitivity setting is directly proportional to the level of “movement” required for the sensor to send a “movement detected signal.” If the user had used a higher sensitivity setting (such as 8) in the previous calibration run, the longest idle period may have been shorter than 36 seconds since more subtle movements were not detected with a sensitivity setting of 5. Accordingly, the user can select the appropriate sensitivity setting to minimize the “longest idle” time that is likely to be observed when the user remains in front of the workstation. This objective generally must be balanced against the objective of eliminating false positives (instances where the sensor detects movement when the user is not in front of the workstation).

Using calibration tool 32, the user may also set the time period for sending a log off command. If the user selects the sensitivity setting of 5, then the user should set a time delay period greater than 36 seconds so that the computer is less likely to log out when the user is still in front of the workstation. Alternatively, calibration tool 32 may include an automatic calibration module. The automatic calibration module may include an algorithm for balancing the sensitivity setting and the time delay period automatically.

Once the sensor and program are calibrated to the user's workstation, program 30 runs in background mode to detect instances when the user leaves the region around the workstation. If the user selects a time delay period of 1 minute, comparator 38 observes the sensory data until a time lapse greater than 1 minute occurs between “movement” signals. For example, after every “movement” is detected, a time delay counter counts 60 seconds. Each “movement” signal restarts the counter. If the counter reaches 60 seconds, central processing unit 26 is directed to send command 44 to log the user out.

The preceding description contains significant detail regarding the novel aspects of the present invention. It should not be construed, however, as limiting the scope of the invention but rather as providing illustrations of the preferred embodiments of the invention. As an example, the aforementioned security system may block access in many ways other than logging out of the user's account, including limiting the display of screens, specific data or programs, as well as preventing the copying and writing of files. In addition, access may also be blocked without actually closing programs. The specific implementation of the security may vary based on the user's needs. Also, other sensors which relay sensory information may be used than the examples provided in the preceding description. For example, pressure sensitive pads may be used on or under the user's chair to detect the presence of the user. Such variations would not alter the function of the invention. Thus, the scope of the invention should be fixed by the following claims, rather than by the examples given.

Having described my invention, I claim:

1. A computer security system for inhibiting access of an unauthorized user to a computer normally used by an authorized user at a workstation comprising:
a. a sensor configured to collect sensory data about a region around said workstation, said sensory data indicating whether a person is present or absent in said region around said workstation, and transmit said sensory data to an electronic circuit;
b. a processing unit electronically connected to said electronic circuit, said processing unit configured to process said sensory data to determine whether a person is present in said region around said workstation; and
c. wherein said processing unit is further configured to send a command signal if said processing unit determines that no person is present in said region around said workstation for a period of time, said command signal configured to block access to said computer until said authorized user completes an authentication process with respect to said computer.

2. The computer security system of claim 1, wherein said sensor comprises a motion detector configured to detect the movement of objects in said region around said workstation.

3. The computer security system of claim 1, wherein said sensor comprises a thermal sensor configured to detect the relative temperature of objects in said region around said workstation.

4. The computer security system of claim 1, wherein said sensor comprises an electro-optical sensor configured to transmit pictorial information about said region around said workstation to said processing unit.

5. The computer security system of claim 1, wherein said sensor comprises a pressure sensitive sensor configured to detect the presence of said user by pressure supplied to said authorized user's chair.

6. The computer security system of claim 1, further comprising a memory unit associated with said processing unit, said memory unit including a computer program, said computer program having a program module for directing said processing unit in making the determination of whether a person is present in said region around said workstation.

7. The computer security system of claim 6, said computer program further comprising a calibration module for calibrating said computer program with said sensor and a default state of said region around said workstation.

8. The computer security system of claim 6, wherein said program module further directs said processing unit to:
a. sample said sensory data as a sensory data sample; and
b. compare said sensory data sample with stored sensory data describing a default state of said region around said workstation.

9. The computer security system of claim 7, wherein said program module further directs said processing unit to:
a. sample said sensory data as a sensory data sample;
b. compare said sensory data sample with stored sensory data describing said default state of said region around said workstation; and
c. compare the differences between said sensory data sample and said stored data with a sensitivity threshold.

10. The computer security system of claim 9, wherein said program module further directs said processing unit to send said command signal if said differences between said sensory data sample and said stored data exceed said sensitivity threshold.

11. The computer security system of claim 2, wherein said command signal provokes said computer to logout of the account of said authorized user.

12. A computer security system for inhibiting access of an unauthorized user to a computer normally used by an authorized user at a workstation comprising:
a. a sensing means configured to detect whether a person is present in a region around said workstation; and
b. a processing means configured to transmit a command signal to said computer if said sensing means does not detect a person in said region around said work station for a period of time, said command signal configured to block access to said computer until said authorized user completes an authentication process with respect to said computer.

13. The computer security system of claim 12, wherein said sensing means comprises a motion detector configured to detect the movement of objects in said region around said workstation.

14. The computer security system of claim 12, wherein said sensing means comprises a thermal sensor configured to detect the relative temperature of objects in said region around said workstation.

15. The computer security system of claim 12, further comprising a memory unit associated with said processing means, said memory unit including a computer program, said computer program having a program module for directing said sensing means in making the determination of whether a person is present in said region around said workstation.

16. The computer security system of claim 15, said computer program further comprising a calibration module for calibrating said computer program with said sensing means and a default state of said region around said workstation.

17. The computer security system of claim 15, wherein said sensing means is further configured to collect sensory data about said region around said workstation, and wherein said program module further directs said processing means to:
a. sample said sensory data as a sensory data sample; and
b. compare said sensory data sample with stored sensory data describing a default state of said region around said workstation.

18. The computer security system of claim 16, wherein said sensing means is further configured to collect sensory data about said region around said workstation, and wherein said program module further directs said processing means to:
a. sample said sensory data as a sensory data sample;
b. compare said sensory data sample with stored sensory data describing said default state of said region around said workstation; and
c. compare the differences between said sensory data sample and said stored data with a sensitivity threshold.

19. The computer security system of claim 18, wherein said program module further directs said processing means to send said command signal if said differences between said sensory data sample and said stored data exceed said sensitivity threshold.

20. The computer security system of claim 12, wherein said command signal provokes said computer to logout of the account of said authorized user.
